(19) United States
(12) Patent Application Publication
(10) Pub. No.: US 2017/0313945 A1
(43) Pub. Date: Nov. 2, 2017

(54) METHOD AND APPARATUS FOR RAPID DRY CARBONIZATION OF ORGANIC WASTE, APPARATUS AND CATALYTIC SYSTEM ASSOCIATED TO THE METHOD

(71) Applicant: RIMA INDUSTRIES S.A.L (HOLDING COMPANY), Beirut (LB)

(72) Inventor: Jamil RIMA, Beirut (LB)

(21) Appl. No.: 15/520,010

(22) PCT Filed: Oct. 23, 2015
(86) PCT No.: PCT/EP2015/074658

§ 371 Date: Apr. 18, 2017

(30) Foreign Application Priority Data
Oct. 23, 2014 (EP) 14190165.2

(51) Int. Cl. C10B 53/07; C10B 23/00; B09B 3/00; B01J 37/02; B01J 35/02; B01J 23/06; B01J 21/18; B01J 6/00; C10B 57/10; C01B 32/05

(52) U.S. Cl. CPC C10B 53/07; C10B 57/10; C10B 23/00; B09B 3/0083; B01J 37/0236; C01B 32/05; B01J 35/02; B01J 23/06; B01J 21/18; B01J 6/008; B01J 37/0219

(57) ABSTRACT

A method for transforming waste into carbon in a reactor, said method comprising: a) drying the waste by submitting said waste to a pressure of at least 3 bar, and a temperature of at least 250° C.; b) releasing the water vapor out of the reactor, and; c) carbonizing at least partially the waste by maintaining said waste during a period of time of at least 5 minutes to a pressure of at least 3 bar, and a temperature of at least 250° C., thereby obtaining carbon; and d) optionally separating non-organic material from the obtained carbon.

### FIELD OF THE INVENTION

The technical field relates to transforming organic waste into coal, carbonization processes and apparatus, as well as catalytic systems.

### BACKGROUND OF THE INVENTION

As the world population is growing, so is the waste generation. Waste impact on the environment, the economy, and society as a whole, is becoming a serious problem for the planet.

There are currently several options to dispose of organic waste. One of them, controlled landfilling, is based on the burial of solid waste, and is performed by spreading non-hazardous waste in layers, holes, or trenches dug in the ground, compacting them, and covering them with earth at the end of each working day. Unfortunately, this process results in the emission of toxic gases and might lead to spontaneous ignitions and explosions due to build-up of methane. The main costs associated with controlled landfilling include the land acquisition costs, lining the ground with impervious plastic sheeting to prevent leakage of dangerous substances into the soil and underground water and aquifers, transportation to remote and very large landfill sites, and continuous monitoring/treatment to avoid excessive methane build-up. If leakages or methane build-up are present,the landfill requires fixing prior to dumping.

Aerobic and anaerobic digesting or composting technologies involve the breakdown of organic waste by microorganisms, generally bacteria and fungi, into simpler forms. These microorganisms use the carbon in the waste as an energy source. The decomposition of the nitrogen-containing materials results in the breakdown of the original materials into a much more uniform product which can be used as soil enrichment. Heat generated during the process kills many unwanted organisms such as weed seeds and pathogens. Anaerobic composting results in fermentation of a portion of the waste. With such technologies in general, large spaces are required, which can also be expensive. The process of composting anaerobically produces a biogas (e.g. methane ammoniac and carbon dioxide). Since anaerobic composting occurs in a sealed oxygen free environment or under water, decomposition of the organic materials can lead to very unpleasant odours due to the release of sulfur-containing compounds such as hydrogen sulphide. One of the main disadvantages of anaerobic composting is that if the compost is not allowed adequate time (at least one year) to ferment and to breakdown the biomass feedstock, there is a risk that the compost will contain harmful pathogens. Also, if leakages occur, underground water may become contaminated. In addition, the fertilizer produced by composting is of poor quality, containing few carbon and nitrogen because during fermentation the carbon and the nitrogen were transformed into carbon dioxide and ammonia.

Methanisation is a waste treatment method where biogas is naturally produced through the fermentation of many different types of animal- and plant-derived organic matter from waste treatment plants and even landfills. Methanisation can provide heating, electricity or fuel. It is nevertheless a complex process leading to the generation of methane and carbon dioxide; it is highly capital intensive compared to other existing technologies especially those projects based on biomethanisation technology, since critical and expensive equipment are needed; and it is not suitable for waste containing few biodegradable matter. In addition, leackage prevention is required to avoid underground waste pollution.

Incineration is a thermal waste treatment that involves the combustion of organic substances contained in waste materials, converting them into ash and flue gas. The ash is mostly formed by the inorganic constituents of the waste, and may take the form of either solid lumps or particles carried by the flue gas. The generated flue gases must be cleaned of possibly toxic pollutants before they are disseminated into the atmosphere. In some cases, the heat generated by incineration can be used to generate electric power through steam. It can reduce the waste volume and weight. Unfortunately it might also result in the emission of toxic gases like dioxin, furan, and NOx gases, which requires monitoring and treating the air. The cost of an incineration plant is high and operating personnel needs to be skilled and trained. In addition, some waste materials require additional fuel to incinerate them.

Waste gasification involves the reaction of carbonaceous feedstock with an oxygen-containing reagent, usually oxygen, air, steam or carbon dioxide, generally at temperatures in excess of 700° C. It involves the partial oxidation of a substance which implies that oxygen is added but the amounts are not sufficient to allow the fuel to be completely oxidized and full combustion to occur. The process is largely exothermic but some heat may be required to initiate and sustain the gasification process. The main product is a syngas, which contains carbon monoxide, hydrogen and methane. The other main product produced by gasification is a solid residue of non-combustible materials (ash) which contains a relatively low level of carbon. During gasification, tars, heavy metals, halogens and alkaline compounds are released within the product gas and can cause environmental and operational problems. Tars are high molecular weight organic gases that ruin reforming catalysts, sulfur removal systems, ceramic filters and increase the occurrence of slagging in boilers and on other metal and refractory surfaces. Alkalis can increase agglomeration in fluidized beds that are used in some gasification systems and also can ruin gas turbines during combustion. Heavy metals are toxic and accumulate if released into the environment. Halogens are corrosive and are a cause of acid rain if emitted to the environment.

Plasma arc technology is based on electricity fed to a torch creating an electric arc between two electrodes. Inert gas is then blown through the electric arc heating it up to extremely high temperature. Due to these extremely high temperatures the waste is gassified. At these temperatures all inorganic materials such as metal, silica, concrete, gravel, glass, etc. or organic materials are vitrified and after cooling fall to the bottom of the oven. The resulting material should be stored to cool before being discharged. This technology is usually employed in the treatment of hazardous waste. It is a very complicated and very expensive technology. It requires the replacement of the plasma torch continuously, and it produces very high and unacceptable noise pollution.

Pyrolysis is a type of thermolysis, i.e. a thermochemical decomposition, which occurs in organic materials exposed to high temperatures and in the absence of oxygen, humidity, and any halogen. Pyrolysis requires the organic material to be dry (usually less than 10% moisture) before it enters the reaction chamber. It involves the irreversible and simultaneous change of chemical composition and physical state. It works under pressures ranging from 1 to 4.5 bars and at temperatures in the range of 400 to 600° C., sometimes up to 1200° C., and the residence time is several hours. In general, pyrolysis of organic substances produces gas and liquid (water and bio-oil) products and leaves a solid residue rich in carbon content and char. Pyrolysis is used heavily in the chemical industry. It is also one of the processes involved in charring wood, and also occurs in fires where solid fuels are burning or when vegetation comes into contact with lava in volcanic eruptions. Extreme pyrolysis, which leaves mostly carbon as the residue, is called carbonization. As disadvantages, waste must be shredded or separated before entering the pyrolysis unit to prevent blockage of the feed and transport systems. It results in the production of high concentration of CO gases, which need to be treated. Furthermore, pyrolytic oils and tars contain toxic and carcinogenic compounds.

There is indeed an unresolved need for a process of waste treatment that is at least, compared to the state of the art technologies, less costly, in need of less space, environmental friendly with no emission of pollutants, is fast, or that can reduce the waste volume to a minimum.

W02008081407A2 (Antacor Ltd.) discloses a hydrothermal carbonization, i.e. a solid-liquid heating system, where the pressure is adjusted to at least 7 bars and varies between 10 to 34 bars, the temperature varies between 100 and 300° C. The time of treatment is at least 2 hours and can be between 12 and 60 hours. The starting materials must be cut in millimeters. The process needs pretreatment by incubation of the materials in an acid during 2 to 6 hours. The catalyst must be added before and after the treatment. This catalyst is a (di-, tri-)carboxylic acid or sulfuric acid. Metals are also used as catalyst, these metals are heavy metals and might be toxic. The process employs a liquid jet mixing pump during the treatment. After treatment the end product is a kind of sludge and the water needs to be removed and the material dried. The water is treated by nano-filtration or reverse osmosis. The process is based on the Maillard reaction (chemical reaction between amino acid and reducing sugar), which involves three stages of treatment. The end products are peat, lignite, black coal humus (a kind of fertilizer). The final products represent 65% of the original starting mass. In the said process, reducing hydrogen, O₂, and N₂ are employed.

Lebanese patent LB 9444 (Dr. Jamil Rima) claims a wet carbonization process to transform solid organic waste into coal. The following conditions are applied to the reactor: 1) fixing air pressure at 10 bars; (2) fixing temperature at 450° C.; (3) introducing the catalyst which is made out of graphite and helium gases. According to this disclosure, after introducing the garbage into the reactor and after appropriate conditioning, organic material is transformed into carbon in fifteen minutes and with no toxic emissions. Unfortunately, this method does not work as water remains in the reactor thereby interefering with the carbonization reaction. Char is obtained instead of coal. Noteworthy, organic waste has a 70-80% of water content.

Rima et al. (Journal of Applied Sciences Research, 9(3): 1666-1674, 2013) disclose a carbonization process using high pressure and temperature to treat medical and municipality wastes for coal production. Chars are obtained according to this process. No details are provided regarding the catalyst, mechanism and the conditions used for carbonization of the organic solid waste.

WO2014/032844A1 (Hempel A S) discloses anti-corrosive coating compositions comprising a binder system, zinc particles, hollow glass microspheres, and a conductive pigment like graphite.

It is an objective of the present invention to provide a process that can carbonize organic waste, including but not limited to, municipalities solid waste, most hospital waste, expired drugs, slaughterhouse waste, sludge collected from sewage, and industrial organic waste, without any toxic emissions.

It is an objective of the present invention to provide a waste treatment process, equipment, and materials, which require a relatively small investment as compared to the state-of-the-art technologies.

It is an objective of the present invention to provide a waste treatment process that has a low operating cost as it requires minimal labor and energy resources.

It is an objective of the present invention to provide a waste treatment process that is quick, requiring a period of 15 to 35 minutes to transform the waste to carbon.

It is an objective of the present invention to provide a waste treatment process that is versatile, that it can work with starting materials having a humidity of more than 80%, or that can work in the presence of halogen, or that requires minimal sorting of the waste prior to applying the treatment process.

It is an objective of the present invention to provide a waste treatment equipment that needs a small area to operate and is durable.

It is an objective of the present invention to provide a waste treatment process that is carbon neutral (or even carbon diminishing in some cases) so it is not polluting, has no toxic emissions, and is thus environmentally friendly.

It is an objective of the present invention to provide a waste treatment process that produces high quality carbon, which can be used or sold as a source of energy.

It is an objective of the present invention to provide a waste treatment process that produces steam which can then be cooled and transformed to distilled water.

It is an objective of the present invention to provide a waste treatment process that reduces both the volume and the weight of waste.

It is an objective of the present invention to provide a waste treatment process that requires minimal sorting of the waste prior to treatment as non-organic waste such as metal or glass is not transformed into carbon.

It is an objective of the present invention to provide a waste treatment process that allows for the treatment of most medical waste without the need for traditional sterilization and without toxic emissions.

The present invention attempts to meet at least one of the above mentioned objectives.

Surprisingly, the inventor has found that by fine-tuning the conditions and steps applied in the reactor, which conceptually involve the complete drying of the waste (water is substantially removed) before carbonization starts, it results in a fully optimized carbonization process.

Surprisingly, the inventor has found that by speeding the rate of heating and pressure, an improved method is obtained, where the entire starting material is carbonized in about 5 to 35 minutes.

Surprisingly, the inventor has also found that by selecting the appropriate mixture of catalysts, it improves the appropriate distribution of heat inside the waste materials being treated.

Surprisingly, the inventor has also found that by coating the internal walls of the reactor with one catalyst composition, only external catalytic gas alimentation is needed for each run, which catalytic gas is provided in bottles, simplifying thereby the process enormously.

Surprisingly, the inventor has also found that only external catalytic gas alimentation mixed with nanofluids is needed for each run, simplifying thereby the process enormously.

### BRIEF DESCRIPTION OF THE FIGURES

FIG. 1 is a representation of some of the chemical constituents of organic waste.

FIG. 2 shows the internal breaking of the C—C bonds in a molecule.

FIG. 3 is a scheme representing the constituents and transformed material from waste material. The humidity is ejected as steam water while the organic matter is transformed into carbon.

FIG. 4 is a picture of a reactor configured according to the present invention and with a capacity of 3500 kg.

FIGS. 5A and 5B show the same material, pharmaceutical products, before and after carbonization.

FIGS. 6A and 6B show the same material, polyethylene bottle, before and after carbonization.

FIGS. 7A and 7B show the same material, leather, before and after carbonization.

FIGS. 8A and 8B show the same material, cabbage, before and after carbonization.

FIGS. 9A and 9B show the same material, banana, before and after carbonization.

FIGS. 10A and 10B show the same material, waste, before and after carbonization.

FIG. 11 shows the effect of temperature on the carbonization level, i.e. expressed as the percentage of generated carbon when setting the pressure to 10 bars and increasing the temperature from 150° C. to 450° C.

FIG. 12 shows the impact of pressure on the carbonization and ash formation levels, expressed as the percentage of the carbon and ash obtained when setting the temperature to 400° C. and increasing the pressure from 1 to 10 bars.

FIG. 13 shows the carbon obtained from 3.5 tons of municipal solid waste after being submitted during 15 minutes to the conditions described in Example 2.

FIG. 14 shows the steam water ejected from the reactor containing the 3.5 tons of municipal solid waste after being submitted during 15 minutes to the conditions described in Example 2.

### SUMMARY OF THE INVENTION

Rapid carbonization of waste and organic material is a technology that can transform waste and organic material in general into carbon, and which technology can be used without producing any environmentally toxic emissions. The final products are carbon and water, such as notably distilled water, in addition to non-organic materials, if present in the starting material. This technology is capable of transforming waste and organic material into carbon within 5 to 35 minutes. It is environmentally friendly, and an economical method. The obtained carbon can be reused for generation of heat, for example in cement manufacturing or other metallurgic industries. This technology is also a new source of clean and hot water.

The basis of this invention relies on the combination of a first step of drying the starting material, if not yet dry, applying heat (wherein the temperature is maintained at 250 to 450° C., preferably at 350 to 450° C.), an air pressure above 3 bars, preferably above 8 bars, in a short period of time, thereby carbonizing organic material and converting it into carbon. This is possible by an effective and fast transfer of heat, which in one embodiment is achieved by means of a catalytic system that entraps and diffuses the heat into the material to be carbonized, in a highly effective manner. In another embodiment, it is achieved by means of a catalytic system that diffuses the heat into the material to be carbonized. This invention has the additional advantage that is its ability to work with the presence of both oxygen and humidity.

### DETAILED DESCRIPTION OF THE INVENTION

The present invention works by combining heat, air pressure, and a rapid transfer of heat, in one embodiment by means of a catalytic system, thereby transforming organic material into carbon in a short period of time. Humidity is transformed to water vapor.

Said water vapor can then be cooled to become water, such as notably distilled water. Starting organic materials after processing become high-purity carbon, preferably in a 92% to 97% content.

The present invention is capable of carbonizing organic waste (for example municipality waste, hospital waste, expired drugs, slaughter house waste, skins and meat, sewage sludge, industrial organic waste, etc.) and can work both in the presence or absence of oxygen and in the presence or lack of moisture.

The beneficial results of this invention, include production of carbon as an energy source; production of water vapor/distilled water which can be further used; space required of use is small; processing time is fast; cost is low; and the process is environment friendly without causing any toxic emissions. In particular, the present invention is capable of dealing with most hospital waste by transforming it to carbon without the need for sterilization. The invention is also capable of processing expired drugs by transforming them to carbon without any toxic emissions. The invention is also capable to transform sewage sludge to carbon without any toxic emissions. The invention is also capable of transforming slaughter house waste to carbon without any toxic emissions.

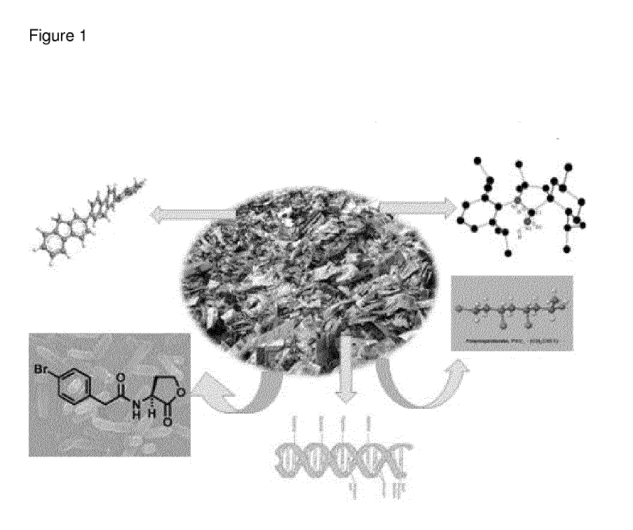

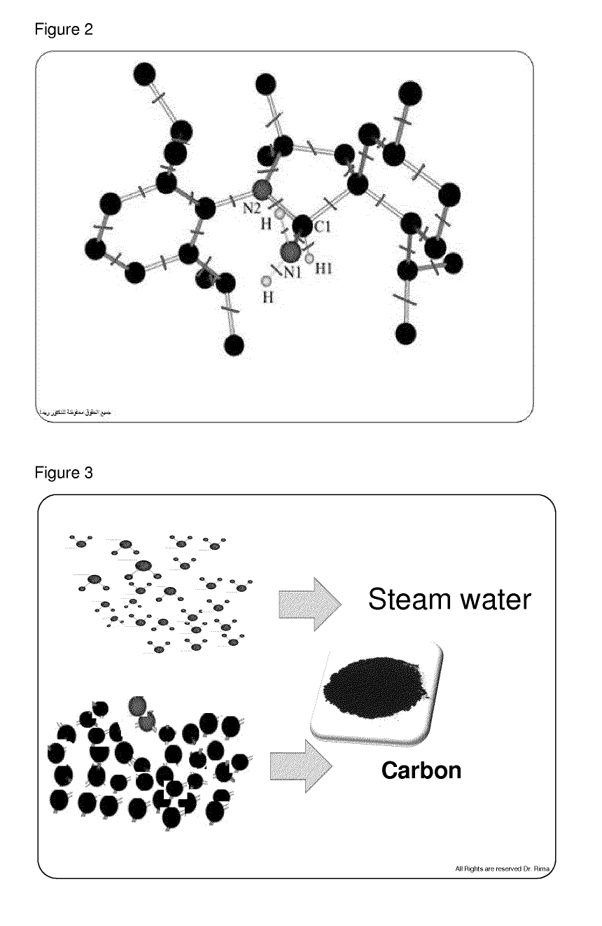

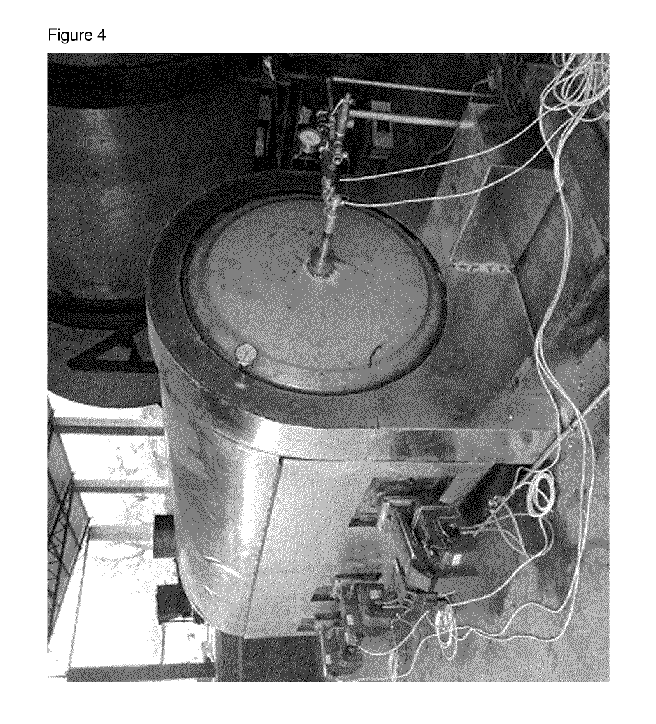

The process according to the present invention works as follows. The chemical molecules which form the starting waste include a large number of molecules like those shown in FIG. 1. After water evaporates, the bonds holding the carbon molecules start to break as it is shown in the below FIG. 2. At the end of the required cycle, all the water is extracted from the organic material in the form of water vapor and all the remaining material transforms into coal (carbon) as it is shown in FIG. 3.

Testing has shown that after cooling the water, vapor transforms into distilled water and that the carbon produced from the above-mentioned carbonization process represents a high purity carbon (like 95% to 98%) of the dry material after water evaporation as set out in the Table below:

| No. | Sample | Trial | % N | % C | % H | % S |
|---|---|---|---|---|---|---|
| 1 | Solid | 1 | 0 | 97.8558 | 0 | 0 |
| 2 | Solid | 2 | 0 | 98.1207 | 0 | 0 |

After evaporating the water from the processed waste, only the dry material remains which, under the influence of heat, air pressure, and the fast transfer of heat into the waste, in one embodiment by means of a catalytic system, it transforms into carbon through the internal breaking of C—C bonds of the organic molecules. Breaking of C—C bonds is achieved in a fast, economic, clean, and efficient way according to the present invention.

The invention relies on the speed by which the heat reaches the required temperature level and the diffusing capabitlity to transfer the heat to all the components of the organic material inside the reactor.

As an example of a way to achieve this speed of heat transfer, the present invention provides a catalytic system comprising a heat trapping composition made out of graphite and prepared with the SOL-GEL technique and coating the inside walls of the reactor (this material is known for its ability to absorb high levels of heat) in addition to the use of a mixture of thermal conductive gases including helium, nanofluids, and any mixture thereof. This mixture of gases or the nanofluids, known for their high calorific conductivity after absorbing the heat kept by the materials prepared through the SOL-GEL method, disperses or vehiculates said heat inside the waste material which needs to be processed, which dispersion ensures that the heat is spread in the required speed and throughout the entire mass of the waste material.

As another example of a way to achieve this speed of heat transfer, the present invention provides a catalytic system comprising a mixture of thermal conductive gases including helium mixed with nanofluids materials. This mixture of gases mixed with nanofluid materials, known for its high calorific conductivity, disperses or vehiculates said heat inside the waste material which needs to be processed, which dispersion ensures that the heat is spread in the required speed and throughout the entire mass of the waste material.

Another important aspect is the use of high pressure inside the reactor, which needs to reach 3 bars or more, preferably 7 bars or more, more preferably 8 bars or more, which high pressure prevents combustion reactions, with the consequent undesirable formation of more ash than carbon.

### Embodiments

The present invention relates to a method for transforming waste into carbon in a reactor, said method comprising:

a) drying the waste by submitting said waste to a pressure of at least 3 bar, and a temperature of at least 250° C.;

b) releasing the water vapor out of the reactor, and;

c) carbonizing at least partially the waste by maintaining said waste during a period of time of at least 5 minutes to a pressure of at least 3 bar, and a temperature of at least 250° C., thereby obtaining carbon; and

d) optionally separating non-organic material from the obtained carbon.

It is understood that the released vapor can be cooled to water. Optionally, distilled water can be obtained by cooling said released water vapor.

In one embodiment, in step a) and in step c), said pressure is, each independently, at least 4 bar, at least 5 bar, at least 6 bar, at least 7 bar, at least 8 bar, at least 9 bar, or at least 10 bar.

In one embodiment, in step a) and in step c), said temperature is, each independently, at least 275° C., at least 300° C., at least 325° C., or at least 350° C.

In one embodiment, in step c), said period of time is at least 7 minutes, at least 10 minutes, at least 15 minutes, or at least 20 minutes.

Preferably, the present invention relates to a method for transforming waste into carbon in a reactor, said method comprising:

a) drying the waste by submitting said waste to a pressure of between 8 and 10 bar, and a temperature between 350 and 450° C.;

b) releasing the water vapor out of the reactor, and;

c) carbonizing at least partially the waste by maintaining said waste during a period of time between 5 to 25 minutes to a pressure between 8 and 10 bar, and a temperature between 350 to 450° C., thereby obtaining carbon; and

d) optionally separating non-organic material from the obtained carbon.

It is understood that the released vapor can be cooled to water. Optionally, distilled water can be obtained by cooling said released water vapor.

In one embodiment, in the method according to the invention, after the carbonizing step c), the method further comprises depressurizing and cooling at a temperature below 100° C. This depressurizing and cooling step allows the safe opening of the reactor and removal of the converted carbon and optionally, if present, of the non-organic material.

In another embodiment, in the method according to the invention, after the carbonization step c), the method further comprises transfer of the carbon in a chamber, in particular a cooling chamber which is installed below the reactor. Depressurization of said chamber, at a temperature below 100° C. enables flushing the carbon. If desired, at the same time, another batch of waste may be added to the reactor through another room preferably installed above the carbonization reactor thereby replacing the carbonized waste which was transferred in said chamber. In this manner, the method according to the invention is a continuous method thereby allowing to save time and energy.

In one embodiment, in the method according to the invention, the temperature of at least 250° C. is supplied by a heating means and a catalytic system.

In one embodiment, the catalytic system comprises i) a heat trapping composition coating at least partially the inside walls of the reactor, and ii) at least one thermal conductive gas supplied into the reactor.

In one embodiment, the heat trapping composition is made from a colloidal solution comprising i) an inorganic water-based binder that resists temperatures of up to 500° C., ii) a heat trapping powder, and iii) a suitable solvent.

In one embodiment, the heat trapping powder comprises i) a carbon-based powder selected from graphite powder, carbon black powder, carbon nanotubes, carbon fibres, coke, graphene, charcoal powder, and any mixture thereof; and optionally ii) a metal powder selected from zinc, tin, iron, aluminium, tungsten, titanium, zirconium, niobium, boron, any transition metal, and any mixture thereof.

In one embodiment, the heat trapping powder has particle diameters D90 of less than 10 μm on dry sieving.

In one embodiment, the inorganic water-based binder that resists temperatures of up to 500° C. is an inorganic silicon water-based binder.

In one embodiment, the at least one thermal conductive gas is selected from helium, hydrogen, CO₂, CO, argon, ethylene, HCl, H₂S, neon, and any combination thereof.

In one embodiment, the at least one thermal conductive gas is a nanofluid obtained by mixing titanium dioxide nanoparticles and sodium dodecylsulfate in water.

In one embodiment, the at least one thermal conductive gas is a non-explosive mixture of hydrogen and helium, and the hydrogen is supplied into the reactor by means of a hydrogen-generating powder, preferably a hydride powder.

In one embodiment, the hydrogen-generating powder is supplied into the reactor before step b), i.e. when there is still some water or water vapor inside the reactor.

In one embodiment, a nanofluid obtained by, for example, a mixture of titanium dioxide nanoparticles, sodium dodecylsulfate and water (10 g of titanium dioxide, concentration of dodecylsodium sulfate=1 mol per liter) is used in addition to or in substitution of the thermal conductive gas.

In another embodiment, the catalytic system comprises a mixture of at least one thermal conductive gas and at least one nanofluid material (e.g. a thermal conductive nanofluids liquid). Said thermal conductive nanofluids liquid can be supplied into the reactor. An example of such nanofluid material may be a mixture of nanoparticules of tatinium dioxide mixed with sodium dodecylsulfate in aqueous solutions or with other inorganic nanoparticles.

In one embodiment, the waste is selected from municipality solid waste, hospital waste, drugs, slaughterhouse waste, sludge collected from sewage, and industrial organic waste.

In one embodiment, the waste comprises non-organic material such as metal or glass.

In one embodiment, at least a portion of the obtained carbon is recycled to heat the reactor.

The present invention further relates to a reactor for transforming organic material or waste into carbon, characterized in that at least partially the inside walls of the reactor are coated with a heat trapping composition, as defined above, made from a colloidal solution comprising i) an inorganic water-based binder that resists temperatures of up to 500° C., ii) a heat trapping powder, and iii) a suitable solvent.

In one embodiment, said reactor further comprises an inlet for supplying the at least one thermal conductive gas as defined above, and an outlet for releasing the water vapor.

In one embodiment, said reactor further comprises a heating system, a cooling system, an air-pressure system, a security valve, and one or two doors.

The present invention further relates to a colloidal solution comprising i) an inorganic water-based binder that resists temperatures of up to 500° C., ii) a heat trapping powder, and iii) a suitable solvent; wherein the heat trapping powder comprises iia) a carbon-based powder selected from graphite powder, carbon black powder, carbon nanotubes, carbon fibres, coke, graphene, charcoal powder, and any mixture thereof; and optionally iib) a metal powder selected from zinc, tin, iron, aluminium, tungsten, titanium, zirconium, niobium, boron, any transition metal, and any mixture thereof; wherein the heat trapping powder has particle diameters D90 of less than 10 μm on dry sieving; characterized in that the weight ratio of carbon-based powder of the heat trapping powder relative to the inorganic water-based binder is 0.70-1.30:1, preferably 1:1.

The present invention further relates to a heat trapping composition made from the colloidal solution defined above.

The present invention further relates to a catalytic system comprising i) the heat trapping composition as defined above, and ii) at least one thermal conductive gas as defined above.

In one embodiment, the obtained carbon of the present invention has a purity of at least 80%, preferably at least 90% (w/w), more preferably at least 92%, even more preferably at least 95%, yet even more preferably at least 98%.

The present invention further relates to the use of the colloidal solution, the heat trapping composition, the thermal conductive gas, the catalytic system, and the reactor coated with the heat trapping composition of the invention, as agents and tools for carbonization of organic waste.

Definitions

The term “carbonization” or “carbonizing” refers to the conversion of an organic molecules into carbon or a carbon-containing residue, by breaking carbon-carbon bonds.

Catalytic System

The catalytic system of the present invention consists of two main components: a heat trapping composition and at least one thermal conductive gas.

For practical reasons, the heat trapping composition takes the form of a solid layer coating at least partially, preferably most of, or entirely the inside walls of the reactor, but the invention is not limited to this specific form.

The term “coating” refers to a liquid, liquefiable, or mastic composition that, after application to a substrate in a thin layer, converts to a solid film.

The heat trapping composition absorbs the maximum heat at the internal surface of the reactor. The selection of raw materials to be used as heat trapping agentsis based on their resistivity at high temperatures, i.e. up to 500° C. in the present invention, and the potential to absorb the maximum of heat. Graphite is a material that can be used as a heat trapping agent because it supports these high temperatures and at the same time it can absorb the maximum of heat, given that it is a black body. As the person skilled in the art knows, the term “black body” refers to an idealized physical body that absorbs all incident electromagnetic radiation, regardless of frequency or angle of incidence. A black body in thermal equilibrium (that is, at a constant temperature) emits electromagnetic radiation called black-body radiation. The radiation is emitted according to Planck's law, meaning that it has a spectrum that is determined by the temperature alone, not by the body's shape or composition. A black body in thermal equilibrium has two notable properties: (1) It is an ideal emitter: at every frequency, it emits as much energy as or more energy than any other body at the same temperature. (2) It is a diffuse emitter: the energy is radiated isotropically, independent of direction. Equivalents to graphite include, without being limited to, black-coloured anodised aluminium, charcoal powder such as Japanese Bincho charcoal powder, carbon black powder, carbon nanotubes, carbon fibres, coke, graphene, any carbon composite material, or a mixture of at least two of those materials. Of interest here are the physical characteristics, such as heat transfer coefficient, thermal conductivity and heat capacity of the materials used.

Examples of suitable graphites are Graphit AF96/97 Graphitwerk Kropfmühl AG—Germany (graphite); Cond 8/96, Graphite Týn, spot, s.r.o.—Czech Republic (micronized graphite); DonaCarbo S-241, Osaka Gas Chemicals Co, Ltd—Japan (carbon fibre); Minatec 40 cm, Merck KGaA—Germany (mica coated with antimony-doped tin oxide; Raven 1000, ex. Columbian Carbon—USA (carbon black); Carbon black Powercarbon 4300F, ex. Yongfeng Chemicals—China; Lamp Black 103, ex. Degussa AG—Germany (carbon black); Special Black 1000, ex. Orion Engineered Carbons GmbH—Germany (carbon black).

In one embodiment, the heat trapping agent comprises, in addition to a black body-type of material, a metal powder. This metal powder is at least one selected from zinc, tin, iron, aluminium, tungsten, titanium, zirconium, niobium, boron, any transition metal powder, and any combination thereof. Its role is to increase the anti-corrosion properties, to increase the heat conductivity, and the resistance at high temperatures.

In one embodiment, the solid layer coating at least partially, preferably most of, or entirely the inside walls of the reactor, which comprises the black body material, is prepared from a colloidal solution by the sol-gel method: this is a mixture of a solute (around 100 g) consisting of graphite powder and the optional metal powder, preferably zinc, with diameters of less than 10 μm, preferably about 5 μm, and an inorganic water-based binder, preferably an inorganic silicon water-based paint, and a solvent (around 500 mL) consisting of water and an organic solvent like an alcohol, glygol, ethanol, isopropanol. The inner surface of the reactor is painted with this colloidal solution containing the black body material in order for that black body material to store the maximum amount of heat.

The term “colloidal solution” refers to a solution in which a material is evenly dispersed in a liquid. A colloidal solution may be a foam, defined as gas trapped in a liquid, for example aerosol shaving cream; an emulsion, defined as a liquid dispersed in another liquid, for example milk; or a sol, defined as a solid evenly dispersed in a liquid, for example a dispersion of silica particles in a liquid. Preferably, the colloidal solution is a sol, and the sol gel process is employed.

In one embodiment, the colloidal solution of the invention is applied to at least partially the inside walls of the reactor by any conventional means, including but not limited to, by brush, by roller, by air-less spraying, by air-spray, by dipping, etc. The coating is typically applied in a dry film thickness of 5-300 μm.

The term “particle diameter D90 of less than 10 μm” describes the diameter where ninety percent of the distribution has a particle size smaller than 10 μm and ten percent of the distribution has a larger particle size. The particle size distribution of the materials may alternatively be measured using a Helos® Sympatec GmbH laser diffraction apparatus. The parameter D90 is equivalent particle diameters for which the volume cumulative distribution, Q3, assumes a value of 90%.

Preferred inorganic silicon water-based paints include polysiloxanes due to their excellent resistance to ultraviolet light, high temperature (500° C.), oxidation and corrosion. Polysiloxanes have a number of other properties that make them a good choice as coating binders, such as being adhesion promoters and form tenacious bonds with metal. In addition, inorganic polysiloxanes are not combustible.

The polysiloxanes used as a binder system in the present invention comprise at least one curable, polysiloxane modified constituent, wherein a major part of the binder system consists of polysiloxane moieties, i.e. at least 20% by volume solids, such as at least 25% by volume solids , preferably at least 35% by volume solids, e.g. more than 50% by volume solids, of the binder system is represented by polysiloxane moieties.

The polysiloxane moiety should be construed to include any pendant organic substituents, such as alkyl-, phenyl-, saturated cyclic structures, or a combination thereof, and may also comprise curable substituents, examples hereof are alkoxy groups, unsaturated acrylic groups, and the like.

In one embodiment, the polysiloxane has pendant or terminal amino groups, a.k.a.amino-functional polysiloxanes and aminosilanes.

Other suitable polysiloxane systems are e.g. described in WO 96/16109, WO 01/51575 and WO 2009/823691.

The colloidal solution typically comprises a solvent. Examples of solvents are water; alcohols, such as methanol, ethanol, propanol, isopropanol, butanol, isobutanol or benzyl alcohol; alcohol/water mixtures, such as ethanol/water mixtures; aliphatic, cycloaliphatic and aromatic hydrocarbons, such as white spirit, cyclohexane, toluene, xylene and naphtha solvent; ketones, such as methyl ethyl ketone, dimethyl ketone, diethyl ketone, acetone, methylacetate, ethylacetate, propylacetate, methyl isobutyl ketone, methyl isoamyl ketone, diacetone alcohol and cyclohexanone; ether alcohols, such as 2-butoxyethanol, propylene glycol monomethyl ether and butyl diglycol; esters, such as methoxypropyl acetate, n-butyl acetate and 2-ethoxyethyl acetate; and mixtures thereof.

The heat trapping composition coating the inside walls of the reactor is combined with a mixture of gases, which disperses the heat inside the reactor after absorbing it from the heat trapping composition. Heat is dispersed quickly reaching all the matter inside the reactor.

The term “thermal conductive gas” refers to a gas that conducts or transfers heat. Light gases, such as hydrogen and helium typically have high thermal conductivity. Dense gases such as xenon and dichlorodifluoro-methane have low thermal conductivity. The role of the catalytic thermal conductive gas is to transfer the heat trapped from the inner surface of the reactor inwards the materials that are to be treated.

Alternatively, the catalytic system of the present invention comprises two main components: at least one nanofluid material, and at least one thermal conductive gas.

The term nanofluids refers to fluids containing nanometer-sized particles, called nanoparticles. These fluids are engineered colloidal suspensions of nanoparticles in a base fluid. The nanoparticles used in nanofluids are typically made of metals, oxides, carbides, or carbon nanotubes. Common base fluids include water, ethylene glycol and oil.

Preferably, the catalytic system of the present invention comprises (i) nanofluids aqueous solutions and ii) at least one thermal conductive gas supplied into the reactor.

In one embodiment the nanofluid aqueous solution used is a mixture of titanium dioxide nanoparticles, sodium dodecylsulfate and water (10 g of titanium dioxide, concentration of dodecylsodium sulfate=1 mol per liter).

In one embodiment the nanofluid used is a mixture of other inorganic oxide (Mgo, FeO . . . etc), sodium dodecylsulfate and water.

This heat transfer is possible and enhanced by the gas state of matter and the thermal conductivity properties of the selected gas or mixture of gases or nanofluids. This allows that the transfer of heat occurs to all parts of the material which is to be processed. For this purpose the gas or nanofluid must have a relatively high thermal conductivity and at the same time should be able to cross the compacted materials inside the reactor, reaching all parts of the material at a desired speed. Hydrogen possesses the highest thermal conductivity among the gases. Helium has also a high calorific conductivity. Because manipulation of hydrogen may result in explosion, it is preferably mixed with other suitable gases such as helium, in a ratio of 1-2 parts of hydrogen to 10-1000 parts of helium (w/w), preferably 1/1000 (w/w), also preferably 10/1000 (w/w). Typically the helium is injected directly from a bottle of helium into the reactor. The hydrogen can be generated from a chemical reaction between a hydride which is injected as powder inside the reactor and the humidity (water) present inside the reactor. After contact with water the reaction gives rise to following reactions:

NaBH₄+2 H₂O→NaBO₂+4H₂

NaBH₄+4 H₂O [symbol] 4H₂+NaB(OH)₄

The term “hydrogen-generating powder” refers to a powder or powder mixture, that generates hydrogen when contacted with a suitable agent, for example an aqueous solution. An example of hydrogen-generating powder is a hydride. The hydride may be selected from sodium borohydride, sodium hydride, potassium hydride, lithium aluminium hydride, and the like.

Alternatively to hydrogen, CO₂ or other high thermal conductivity gases can be used, but with different ratios than the Hydrogen/Helium ratio stated above. The gas or mixture thereof must be injected during each cycle.

The below table sets out other possible alternatives that can be used in the reactor.

| Gases (ambient temperature | Thermal conductivity |
|---|---|
| and atmospheric pressure) | (mw · cm⁻¹ · k⁻¹) |
| Argon | 0.16 |
| CO₂ | 0.146 |
| CO | 0.232 |
| Ethylene | 0.17 |
| Helium | 1.42 |
| Hydrogen | 1.68 |
| HCL | 0.13 |
| H₂S | 0.13 |
| Neon | 0.46 |

Reference CRC Handbook of chemistry and physics 50 the R. C. Weast Ed the chemical Rubber Co 1969

The following table sets out the different thermal conductivities of the gases: Hydrogen, Helium and CO₂, at different temperature and pressure levels.

| Temperature | Pressure | | Thermal conductivities |
|---|---|---|---|
| (K) | (bar) | gas | (mw · cm⁻¹ · k⁻¹) |
| 350 | 1 | H₂ | 1.686 |
| 350 | 1 | He | 1.42 |
| 350 | 1 | CO₂ | 0.25 |
| 750 | 1 | H₂ | 3.2 |
| 750 | 1 | He | 2.8 |
| 750 | 1 | CO₂ | 0.49 |
| 750 | 10 | H₂ | 7.3 |
| 750 | 10 | He | 6.34 |
| 750 | 10 | CO₂ | 1.2 |

The coefficient of thermal conductivity of the catalysts permits routing the heat to all points in the material present inside the reactor and leads to the carbonization of the organic materials by breaking the C—C bonds.

In one preferred embodiment, the working temperature of the invention is about 450° C. and the working pressure is about 10 bar. As shown in the above table, at this temperature and pressure level, the thermal conductivity of hydrogen and helium in the gaseous state are higher than those of CO₂ and other gases. Thus, there is an advantage in using these gases to transfer the heat more efficiently from the inner walls in the reactor to the compressed materials.

Equipment

The system, device, tank, vessel, apparatus, or reactor can be made out of anti-rust metal, like stainless steel, or an iron-contanining material suitable for heat induction, or any other metal capable of sustaining temperatures up to 500° C. Implementing this invention is done by manufacturing special machines based on the above mentioned specifications to process waste and transforming it into carbon while moisture transforms into distilled water. Machines with different capabilities can be manufactured. Typical capabilities may be, without being limited to, 20kg/15 min, 1,000kg/15 min and 3,500kg/15 min.

The main components of these machines are:
the anti-rust metal vessel or reactor, preferably of cylindrical shape, which is a container that can withstand the heating and pressure conditions of the invention;
a heating system or mechanism which can be powered from different energy sources, such as but not being limited to, electricity, gas, fuel oil, the carbon generated by the machine itself or other ways, and providing sufficient heat to achieve the required temperatures of the process of the invention, the sufficient heat may be in the order of 1000 to 5000 W, preferably around 2000 W;
air pressure system, for example a compressor, which can ensure a working pressure of at least 3 bars, preferably at least 8 bars or at least 10 bars, along with the proper safety release valves, and a pressure controller may be implemented for the regulation and monitoring of the pressure;
the catalytic heat trapping composition mentioned above to expedite the heating process and absorb as much of the required heat. This catalytic heat trapping composition is preferably painted onto the internal walls of the reactor only one time during the production of the reactor. There is usually no need for further coating the inside walls after different cycles, as the above-mentioned coating does not usually deteriorate with the repeated use of the machine;
an inlet to supply or inject the thermal conductive gases, including those precursors like hydrogen-generating powders, which transfer the heat from the reactor walls to all the components of the organic material inside the reactor;
possibly, a dispenser to contain and dispense the nanofluids during the carbonization process;
an outlet to release the water vapour generated inside the reactor;
an activated charcoal filter to remove the undesirable compounds and odors such as carbon powder which is ejected during the depressurization of steam water or some volatile compounds which can be formed before the carbonization;
a cooling system;
optionally a system to separate outgoing air from water;
one or two doors to deposit the waste and to extract the resulting carbon.

Alternatively, these machines may comprise for the heat transfer at the place of catalyst gases or nanofluid, an agitation system in order to insure the contact of the organic material with the internal surface of the body of the reactor.

Process

The combination of all the above mentioned components allows this new technology to treat and transform organic waste, including but not limited to, municipalities solid waste, most hospital waste, expired drugs, slaughterhouse waste, sludge collected from sewage, and industrial organic waste into carbon within 5 to 35 minutes without any toxic emissions.

The carbonization is achieved in two steps. In the first step, as the heat builds up inside the reactor due to the use of the catalytic system of the invention comprising the coating with the heat trapping composition and the thermal conductive gas(es) mentioned above, or due to the use of the catalytic system of the invention comprising a mixture of the thermal conductive gas(es) mentioned above and nanofluid solutions, the humidity present in the waste starts to evaporate. This vapor can then be collected and cooled outside the reactor to result in distilled water. This makes the waste completely dry (i.e. 99 to 100% dry). Typically, carbon represents the majority of this dry material's chemical composition.

In a second step, and once the temperature reaches the appropriate level of at least 250° C., preferably from 350 to 450° C., even up to 500° C., and the pressure is at its appropriate level of at least 3 bar, preferably 8 bar, more preferably 9 bar, even more preferably 10 bar, the flash point is reached and the molecules that make up the waste material are cracked to transform the waste into carbon. As long as the temperature and the pressure are maintained at the required levels, the carbonization process starts and takes from 5 to 35 minutes. Once the cycle is complete, non-organic materials such as metal and glass, which do not transform to carbon, are easily separated from the carbon. This avoids the need to extensively sort the waste prior to treating it with the method of the present invention. No toxic emissions are produced throughout the whole process, thus being an environmentally friendly process. In addition, the obtained carbon can be used as a new source of bio-fuel energy.

In a preferred embodiment, the first step of heat build up, conconmitantly drying the material, is performed as quickly as possible, preferably in 30 minutes, more preferably in 15 minutes or less.

Heat

The present invention depends on heat which needs to reach at least 250° C., preferably between 350 to 450° C. through several possible sources of energy such as electricity, gas, coal or any other appropriate source with the need to accelerate the increase of temperature through the catalytic system of the invention. Heat can be generated and transferred to the reactor from any energy source including but not limited to electricity, gas, fuel oil, coal or any alternatively appropriate source. Heat can also be generated using the Carbon the machine produces itself. Heat inside the reactor preferably reaches 350° C. to 450° C.

Air Pressure

Air pressure should be increased to at least 3 bars, preferably to at least 8, 9, or 10 bars. Pressure is used to ensure the waste is transformed to carbon instead of ash by preventing incineration. Although carbon starts forming at pressure of 3 bars, the preferred implementation of the process of the invention is at a pressure of at least 8 bars, preferably 10 bars, at which carbon formation is full.

### EXAMPLES

### Example 1

### Preparation of the Heat Diffusing Catalytic Colloidal Solution and Internal Coating of a Reactor

Starting materials: Polysiloxane, polysilicon, Graphite 80 mesh, ethanol, and zinc powder were purchased from Merck. Deionized distilled water was locally prepared. The paint was prepared as follows: the graphite powder used in the experiment was man-made graphite with a purity of 98%. The size of the graphite powder particles and of the zinc powder particles was 5 μm or less. The filler materials were the mixture of graphite powder and zinc powder. The colloidal sol was made of 500 ml solvent (400 ml water and 100 ml ethanol) and 100 g of solute composed of graphite powder, zinc powder, and inorganic silicon (polysilicon) water-based paint (polysiloxane or sililoxan). The 100 g solute composition had 25 g graphite, 25 g inorganic silicon, and 50 g zinc. After fifteen minutes stirring, the even sol was formed. Under room temperature and atmospheric pressure, a spraying gun was utilized to spray the prepared sol onto the internal surfaces of a reactor, and then dried in an insulation can at around 100° C. to form a coating of about 350 μm thick.

### Example 2

### Treatment of Municipal Solid Waste

Municipal waste processed with our prototype internally coated reactor proved the validity of the invention. 3.5 tons of municipal waste was collected and was inserted into the reactor which was then pressurized and sealed appropriately to avoid any leakage during the carbonization process. We used an electric heater to heat the reactor and an air compressor to maintain the appropriate pressure.

We started by increasing the pressure to 2 bars, at which moment we started heating the reactor. When internal temperature reached 150-160° C. the pressure increased to 7 bars, and the water present in the reactor started coming out of the reactor as water vapor. At this moment, sodium borohydride powder and helium gas were injected into the reactor. The sodium borohydride reacted with the water still present inside the reactor, thereby generating hydrogen. The mixture of in situ generated hydrogen and injected helium vehiculated the heat from the reactor walls into the waste.

When temperature started reaching 250-300° C. and pressure was about 9 bars, substantially all water present in the reactor had already been released out of the reactor as water vapour.

At this moment, additional helium was injected into the reactor and keeping the pressure at 10 bars and the temperature between 350 and 450° C. during 15 minutes.

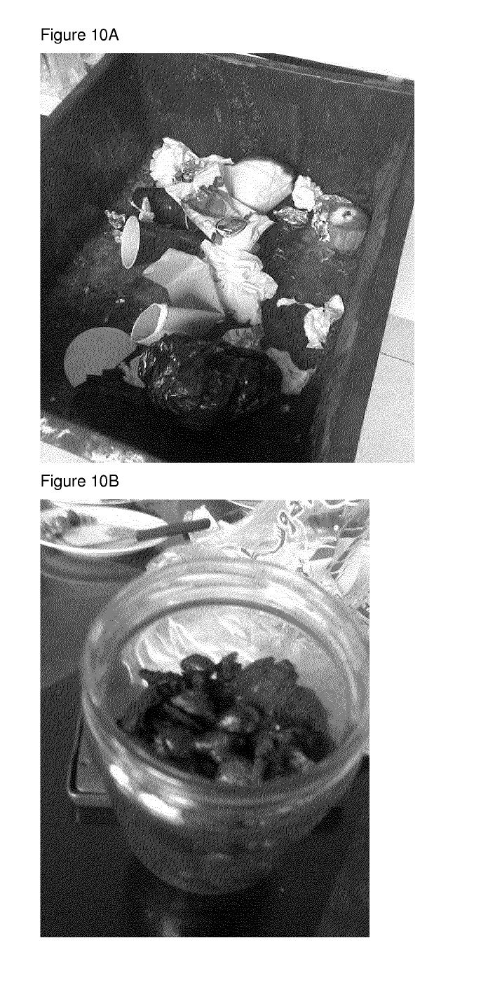

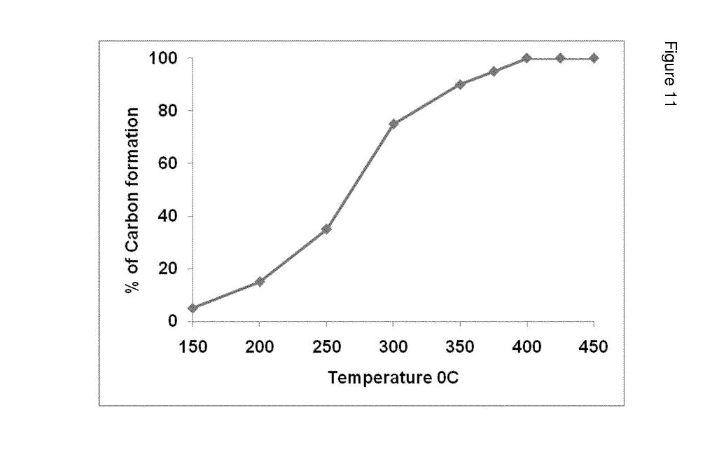

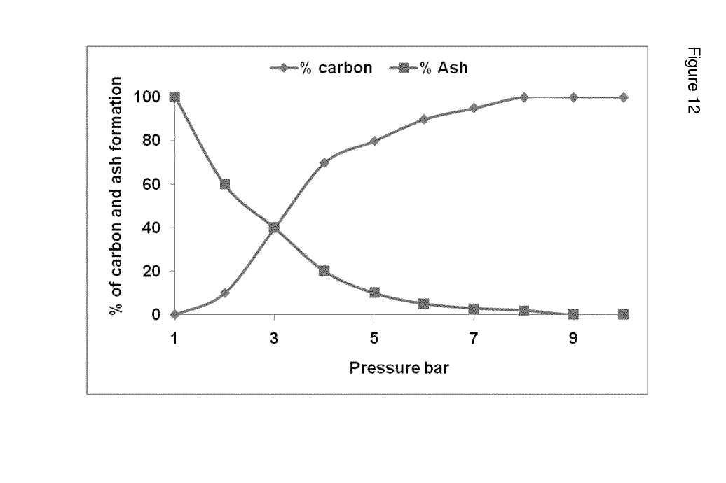

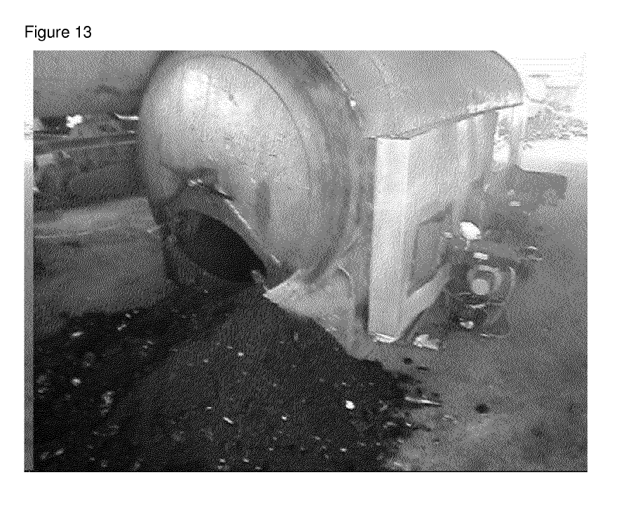

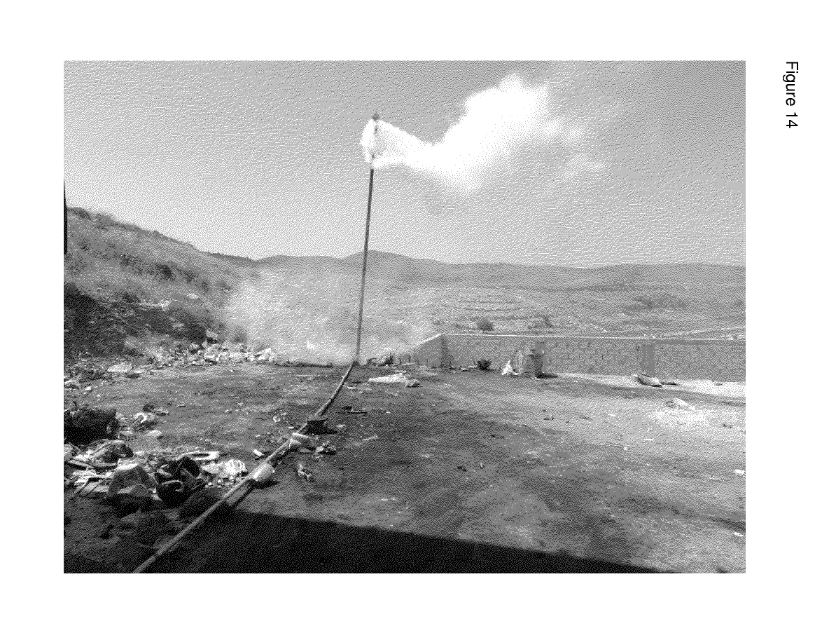

After these 15 minutes, heating was stopped and the reactor was allowed to cool to a temperature below 100° C. The reactor was also depressurized. The reactor was opened and a vacuum system was used to recover the resulting product. The resulting product was made almost entirely of carbon with a total weight of only around 700 kg from the corresponding starting material of 3.5 tons and it proved that the internal breaking of the C—C bonds of the organic compounds took place and thus a conversion of organics into carbon was achieved. FIG. 13 shows the carbon obtained from the starting 3.5 tons of municipalities solid waste. FIG. 14 shows the steam water ejected from the reactor containing 3.5 tons waste and submitted to the conditions mentioned above. FIGS. 10A and 10B show a sample of mixed municipal waste before and after its treatment with the process according the invention. As can be seen in the referred FIGS. 10A and 10B, the resulting product is a black material and had no odors.

### Example 2a

### Treatment of Municipal Solid Waste

Municipal waste processed with our prototype. 3.5 tons of municipal waste was collected and was inserted into the reactor which was then pressurized and sealed appropriately to avoid any leakage during the carbonization process. We used an electric heater to heat the reactor and an air compressor to maintain the appropriate pressure.

We started by increasing the pressure to 2 bars, at which moment we started heating the reactor. When internal temperature reached 150-160° C. the pressure increased to 7 bars, and the water present in the reactor started coming out of the reactor as water vapor. At this moment, sodium borohydride powder and helium gas were injected into the reactor. The sodium borohydride reacted with the water still present inside the reactor, thereby generating hydrogen. The mixture of in situ generated hydrogen and injected helium vehiculated the heat from the reactor walls into the waste

Nanofluids solutions were injected into the material from the beginning of the process (titanium dioxide nanoparticles+sodium dodecylsulfate in aqueous solutions).

An agitator system was used to mix the materials inside the reactor.

When temperature started reaching 250-300° C. and pressure was about 9 bars, substantially all water present in the reactor had already been released out of the reactor as water vapour.

At this moment, additional helium was injected into the reactor and keeping the pressure at 10 bars and the temperature between 350 and 450° C. during 15 minutes.

After 15 minutes, heating was stopped and the reactor was allowed to cool to a temperature below 100° C. The reactor was also depressurized. The reactor was opened and a vacuum system was used to recover the resulting product. The resulting product was made almost entirely of carbon with a total weight of only around 700 kg for the corresponding starting material of 3.5 tons and it proved that the internal breaking of the C—C bonds of the organic compounds took place and thus a conversion of organics into carbon was achieved.

### Example 3

### Treatment of Household Waste

Samples of approximately 1 kg of household waste were introduced into the reactor. Within 15 minutes from placing the household waste inside the reactor and operating it, the resulting material was extracted from the inside of the reactor. All the material had been transformed into coal. Laboratory tests showed that the weight of the coal was 20% to 25% of the original weight of the waste, knowing that the remaining 75% to 80% represented the amount of water inside the waste and the carbon represented 92% to 95% of the remaining dry material after evaporating the water.

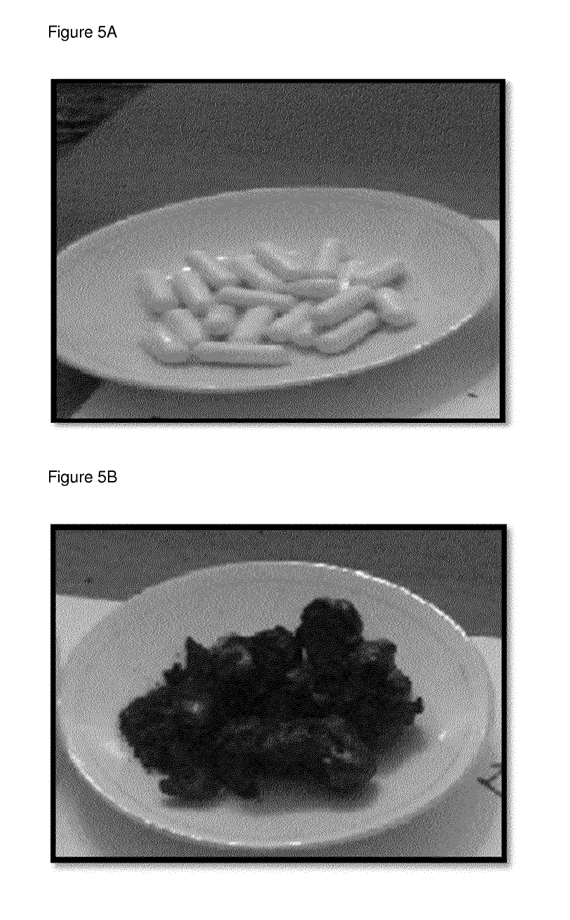

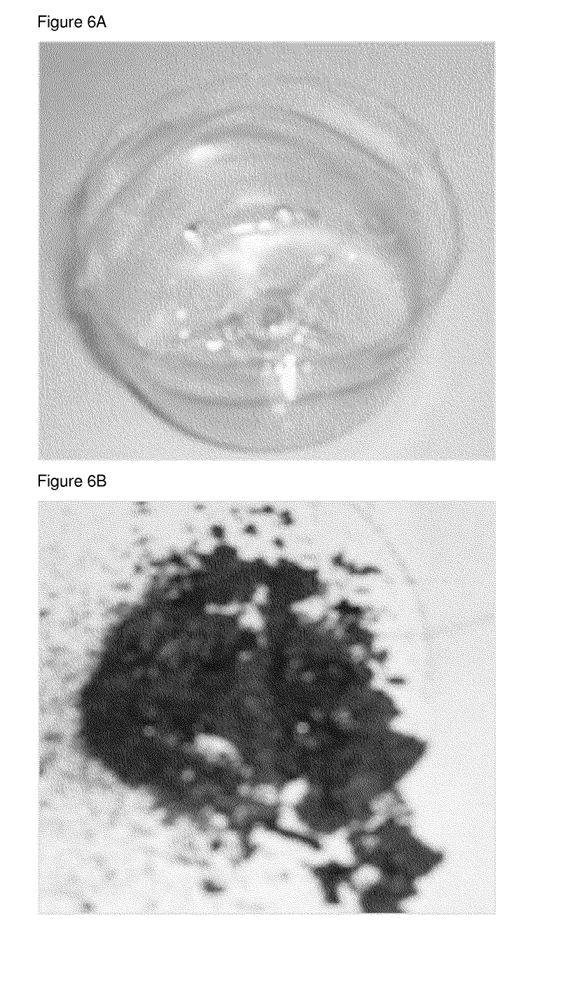

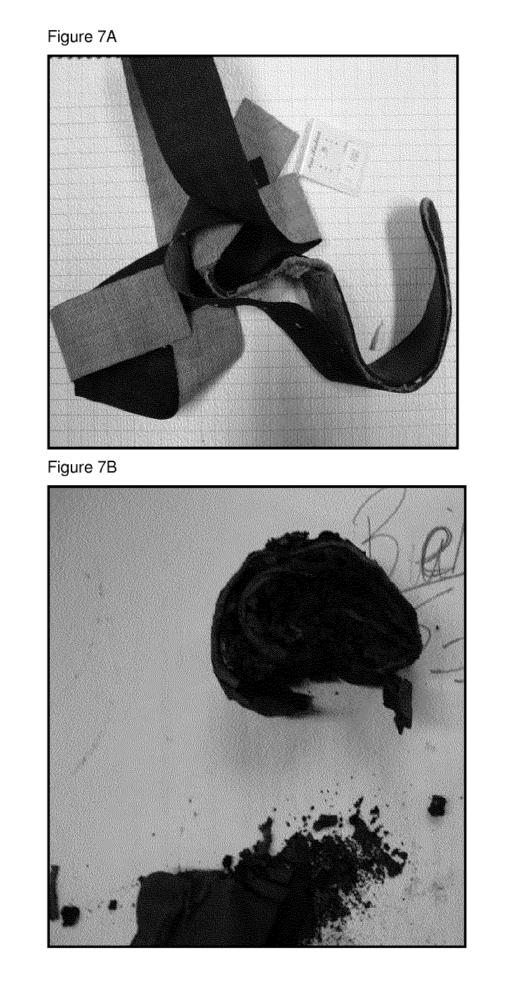

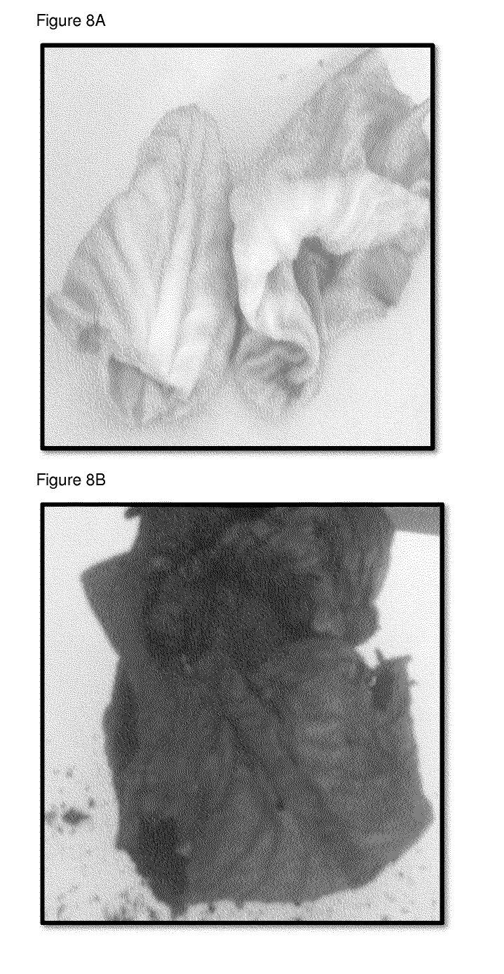

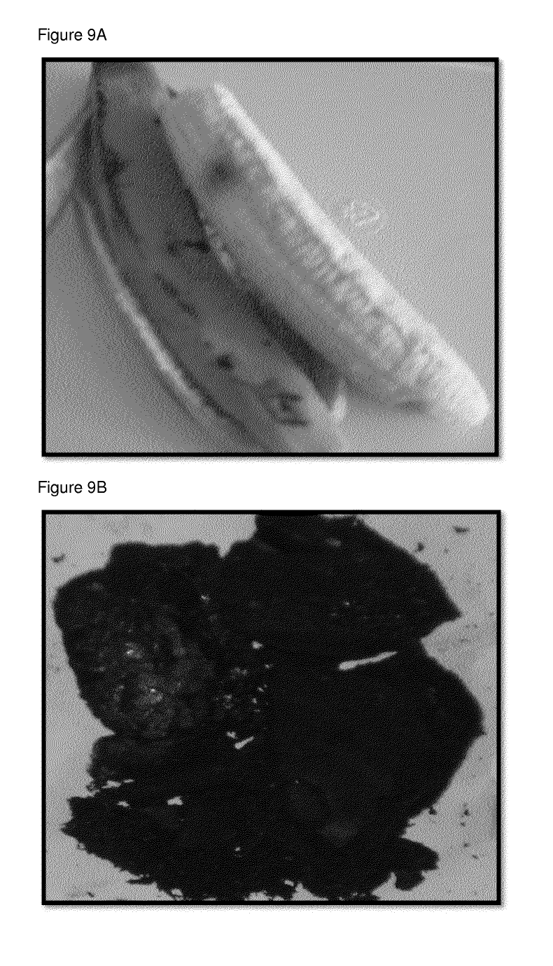

Tests were performed on other kinds of industrial waste like animal meat, animal skin, animal bones, vegetables (FIGS. 8A and 8B), banana fruit (FIGS. 9A and 9B), grains, leather (FIGS. 7A and 7B), polyethylene bottle (FIGS. 6A and 6B), sewage residue (sludge), and expired drugs (FIGS. 5A and 5B), and, just like before, it was shown that after 15 minutes everything was transformed into carbon residue. The resulting product obtained after the carbonization of the different waste samples was analyzed with an Organic Elementary Analysis machine (Flash EA 1112, Thermo Scientific). The elemental analyzer is equipped with two combustion columns, one for the analysis of the carbon, nitrogen, hydrogen and sulfur under high oxygen conditions, while the other column is set up for the oxygen analysis in an oxygen free environment. All of the samples were weighed into either tin or aluminum cups for CHNS analysis or into silver cups for oxygen analysis. The results of the elemental analysis are shown in the Table below:

| Sample | | | | |
|---|---|---|---|---|
| number | % N | % C | % H | % S |
| 1 | 0 | 98 | 0 | 0.2 |
| 2 | 0 | 98.5 | 0 | 0.1 |
| 3 | 0 | 94 | 0 | 0 |
| 4 | 0 | 97 | 0 | 0 |
| 5 | 0 | 93 | 0 | 0.07 |
| 6 | 0 | 97.5 | 0 | 0.5 |
| 7 | 0 | 99 | 0 | 0 |
| 8 | 0 | 98.8 | 0 | 0 |

The results presented in the above table show that the majority of the dry material is carbon and the residual part is constituted by several minerals like potassium, calcium or others nontoxic compounds. The elemental analysis of the samples after their treatment with the process of the invention showed that 90% to 98% of the resulting product was high-purity carbon, depending on the initial waste materials tested. In addition, the weight of the resulting product after the treatment according to the invention, is 20% to 25% of the initial waste before treatment.

### Example 4

### Effect of Temperature on Carbon Formation

To test the effect of temperature on the carbon formation, the pressure inside the reactor was fixed at 10 bars and the temperature was changed from 150° C. to 450° C. For each value of temperature a sample was withdrawn and analyzed by the Organic Elementary Analyzer (Flash EA 1112, Thermo Scientific).

We made several tests on the same amount of organic waste which was carbonized for 15 minutes under different temperatures. For each test, analyses in the Flash EA 1112 machine were conducted to identify the percentage of carbon.

All the obtained results were combined in a graph (FIG. 11) by plotting the mass of carbon obtained in each sample in function of the temperature. FIG. 11 shows that the percentage of carbon formation increases with the increase of the temperature to reach the appropriate level at around 350° C., becoming stable at around 400° C.

### Example 5

### Effect of Pressure on Carbon Formation

To test the effect of pressure on the carbon formation, after fixing the temperature at 450° C., we made several tests on the same amount of organic waste which was carbonized for 15 minutes while changing the air pressure by one unit bar, starting from 1 to 10 bars. For each test, organic elemental analysis was conducted to identify the percentage of carbon and ash after an equal processing time of 15 minutes.

All the obtained results depicted in the graph of FIG. 12, show that carbon starts forming when pressure is more than 3 bars, after 4 bars the carbonization starts to become significant, while the high level of carbonization is reached once the pressure reaches 8 bars, preferably 10 bars. At the atmospheric pressure the material was completely burned and it converted into ash. After 4 bars, the ash formation was minimal and some of the organic material was converted into carbon instead. FIG. 12 shows the evolution of the carbonization in function of pressure change.

1. A method for transforming waste into carbon in a reactor, said method comprising:
a) drying the waste by submitting said waste to a pressure of at least 3 bar, and a temperature of at least 250° C.;
b) releasing the water vapor out of the reactor, and;
c) carbonizing at least partially the waste by maintaining said waste during a period of time of at least 5 minutes to a pressure of at least 3 bar, and a temperature of at least 250° C., thereby obtaining carbon; and
d) optionally separating non-organic material from the obtained carbon.

2. The method according to claim 1, wherein in step a) and in step c), said pressure is, each independently, at least 4 bar, at least 5 bar, at least 6 bar, at least 7 bar, at least 8 bar, at least 9 bar, or at least 10 bar.

3. The method according to claim 1, wherein in step a) and in step c), said temperature is, each independently, at least 275° C., at least 300° C., at least 325° C., or at least 350° C.

4. The method according to claim 3, wherein in step c), said period of time is at least 7 minutes, at least 10 minutes, at least 15 minutes, or at least 20 minutes.

5. The method according to claim 1 wherein said method, after the carbonizing step c), further comprises depressurizing and cooling at a temperature below 100° C.

6. The method according to claim 1, wherein the temperature of at least 250° C. is supplied by a heating means and a catalytic system.

7. The method according to claim 6, wherein the catalytic system comprises
i) at least one nanofluid aqueous solution and ii) at least one thermal conductive gas supplied into the reactor.

8. The method according to claim 7, wherein the at least one thermal conductive gas is selected from helium, hydrogen, CO₂, CO, argon, ethylene, HCl, H₂S, neon, and any combination thereof.

9. The method according to claim 7, wherein the at least one nanofluid aqueous solution is obtained by mixing titanium dioxide nanoparticles and sodium dodecylsulfate in water.

10. The method according to claim 7, wherein the at least one thermal conductive gas is a non-explosive mixture of hydrogen and helium, and the hydrogen is supplied into the reactor by means of a hydride powder.

11. A reactor for transforming organic material or waste into carbon according to the method of claim 1.

12. A catalytic system comprising i) at least one nanofluid aqueous solution and ii) at least one thermal conductive gas as defined in claim 8.

13. The method according to claim 1, wherein the waste is selected from municipality solid waste, hospital waste, drugs, slaughterhouse waste, sludge collected from sewage, and industrial organic waste.

14. The method according to claim 1, wherein the waste comprises non-organic material such as metal or glass.

15. The method according to claim 1, wherein at least a portion of the obtained carbon is recycled to heat the reactor.

16. The reactor according to claim 11, wherein said reactor further comprises an inlet for supplying an at least one thermal conductive gas, and an outlet for releasing the water vapor.

17. The reactor according to claim 11, wherein said reactor further comprises a heating system, a cooling system, an air-pressure system, a security valve, and one or two doors.
